(19) United States
(12) Patent Application Publication
(10) Pub. No.: US 2026/0366621 A1
(43) Pub. Date: Nov. 19, 2026

(54) GASKET DEVICE AND GASKET

(71) Applicant: NOK CORPORATION, Tokyo (JP)

(72) Inventors: Tomohiro KAWAI, Kanagawa (JP); Hajime YUI, Kanagawa (JP)

(21) Appl. No.: 19/142,731

(22) PCT Filed: Nov. 9, 2023
(86) PCT No.: PCT/JP2023/040434

§ 371 Date: Jun. 24, 2025

(30) Foreign Application Priority Data
Dec. 28, 2022 (JP) 2022-212134

(51) Int. Cl. F16J 15/12; C25B 13/02; F16J 15/08

(52) U.S. Cl. CPC F16J 15/127; C25B 13/02; F16J 15/0818; F16J 2015/0856

(57) ABSTRACT

A gasket device includes a gasket and a spacer. The spacer supports, between a separator and an electrolyte membrane, the separator and the electrolyte membrane in a manner such that the separator and the electrolyte membrane, which are the opposed members, are opposed with a space in between. The gasket is configured to surround the space or the space between the separator or the other separator and the electrolyte membrane. The spacer is also configured to surround the gasket from an outer side between the separator and the electrolyte membrane. The gasket and the spacer are configured to come into contact with each other in a stretching direction of the space.

### CROSS REFERENCE TO RELATED APPLICATIONS

The present application is a national phase application of International Patent Application No. PCT/JP2023/040434 filed on Nov. 9, 2023, which claims the benefit of Japanese Patent Application No. 2022-212134, filed on Dec. 28, 2022. The contents of the above applications are incorporated herein by reference in their entirety.

### BACKGROUND

### Technical Field

The present disclosure relates to a gasket device and a gasket.

### Related Art

Each cell of a hydrogen generator or a fuel battery is equipped with a gasket and the gasket is compressed between a separator and an electrolyte membrane, sealing the inside of the cell to prevent the leakage of a gas inside the cell (see, for example, Japanese Patent Application Publication No. 2006-19116).

The pressure of the inside of a cell, which is a space to be sealed, becomes high, which may cause the gasket to deform or shift with a reduction in sealing performance. Accordingly, the gasket of a cell of a fuel battery or a hydrogen generator is required to maintain a sealing performance even when the pressure of the inside of the cell becomes high.

The present disclosure is provided in view of the above-described problem and an object thereof is to provide a gasket device and a gasket capable of maintaining a sealing performance even when the pressure of a space to be sealed becomes high.

### SUMMARY

In order to achieve the above-described object, a gasket device according to the present disclosure is a gasket device for sealing a space between opposed members, the gasket device including: a gasket made of an elastic body; and a spacer that is a member with rigidity for supporting, between the opposed members, the opposed members in a manner such that the opposed members are opposed with the space in between, in which the gasket is configured to surround the space between the opposed members, the spacer is configured to surround the gasket from an outer side or an inner side between the opposed members, and the gasket and the spacer are configured to come into contact with each other in a stretching direction of the space.

In the gasket device according to an aspect of the present disclosure, the gasket and the spacer include, at a contact portion where the gasket and the spacer are configured to come into contact with each other, an engagement portion configured to engage the gasket and the spacer with each other.

In the gasket device according to an aspect of the present disclosure, the engagement portion includes a recessed portion, which is a portion that is recessed, and a received portion, which is a portion to be received in the recessed portion, the spacer includes, at a portion at an end on a side of the gasket in the stretching direction of the space, one of the at least one recessed portion and the at least one received portion, and the gasket includes, at a portion at an end on a side of the spacer in the stretching direction of the space, the other one of the at least one recessed portion and the at least one received portion.

In the gasket device according to an aspect of the present disclosure, the recessed portion is recessed in the opposed direction, and the received portion extends in the opposed direction.

In the gasket device according to an aspect of the present disclosure, the recessed portion is recessed in the stretching direction of the space, and the received portion extends in the stretching direction of the space.

In the gasket device according to an aspect of the present disclosure, the spacer includes a stepped portion at an end portion, the end portion being the portion at the end on the side of the gasket, the stepped portion of the spacer has a first step surface that is a surface facing the side of the gasket and a second step surface that is a surface facing the side of the gasket, the second step surface being located farther on the side of the gasket than the first step surface, and a peripheral end portion of the gasket is configured to, at least in an in-use state, come into contact with the first step surface and the second step surface of the stepped portion of the spacer, the peripheral end portion being the portion at the end on the side of the spacer.

In the gasket device according to an aspect of the present disclosure, the gasket includes a seal bead portion farther on a side opposite to the side of the spacer in the stretching direction of the space than the contact portion, the seal bead portion being a portion projecting toward one of the opposed members, and the seal bead portion annularly extends.

In the gasket device according to an aspect of the present disclosure, the gasket is provided on a side of a target to be sealed with respect to the spacer.

In the gasket device according to an aspect of the present disclosure, the opposed members are a separator and an electrolyte membrane that are used in a cell of a water electrolysis device.

In order to achieve the above-described object, a gasket according to the present disclosure is a gasket made of an elastic body for sealing a space between members, the members being supported by a spacer and opposed, the spacer being a member with rigidity, the gasket being configured to: surround the space between the opposed members; be surrounded by the spacer from an outer side or an inner side; and come into contact with the spacer in a stretching direction of the space.

The gasket according to an aspect of the present disclosure includes an engagement portion at a portion to come into contact with the spacer, the engagement portion being configured to engage the gasket with the spacer.

In the gasket according to an aspect of the present disclosure, the spacer includes, at a portion at an end on a side of the gasket in the stretching direction of the space, one of at least one recessed portion and at least one received portion, the received portion being configured to be received in the recessed portion, and the engagement portion includes, at a portion at an end on a side of the spacer in the stretching direction of the space, the other one of the at least one recessed portion and the at least one received portion.

In the gasket according to an aspect of the present disclosure, the recessed portion is recessed in the opposed direction, and the received portion extends in the opposed direction.

In the gasket according to an aspect of the present disclosure, the recessed portion is recessed in the stretching direction of the space, and the received portion extends in the stretching direction of the space.

In the gasket according to an aspect of the present disclosure, the spacer includes a stepped portion at an end portion, the end portion being the portion at the end on the side of the gasket, the stepped portion of the spacer has a first step surface that is a surface facing the side of the gasket and a second step surface that is a surface facing the side of the gasket, the second step surface being located farther on the side of the gasket than the first step surface, and a peripheral end portion of the gasket is configured to, at least in an in-use state, come into contact with the first step surface and the second step surface of the stepped portion of the spacer, the peripheral end portion being the portion at the end on the side of the spacer.

In the gasket according to an aspect of the present disclosure, the gasket includes a seal bead portion farther on a side opposite to the side of the spacer in the stretching direction of the space than the contact portion, the seal bead portion being a portion projecting toward one of the opposed members, and the seal bead portion annularly extends.

In the gasket according to an aspect of the present disclosure, the gasket is provided on a side of a target to be sealed with respect to the spacer.

In the gasket according to an aspect of the present disclosure, the opposed members are a separator and an electrolyte membrane that are used in a cell of a water electrolysis device.

### Advantageous Effects of the Disclosure

The gasket device and the gasket according to the present disclosure are capable of maintaining a sealing performance even when the pressure of a space to be sealed becomes high.

### BRIEF DESCRIPTION OF THE DRAWINGS

FIG. 1 is a partial cross-sectional view illustrating an outline of a configuration of a cell of a water electrolysis device, which is an application target of a gasket device according to a first embodiment of the present disclosure.

FIG. 2 is a diagram illustrating a separator and the gasket device in the cell illustrated in FIG. 1.

FIG. 3 is a cross-sectional view illustrating a cross section perpendicular to an extending direction of the gasket device, and a cross section along a line A-A in FIG. 2.

FIG. 4 is a partial perspective view illustrating a portion of the gasket device.

FIG. 5 is a partial perspective view illustrating a portion of a spacer of the gasket device.

FIG. 6 is a partial perspective view illustrating a portion of a gasket of the gasket device.

FIG. 7 is a partial perspective view illustrating a portion of a modification example of the gasket device of the first embodiment of the present disclosure.

FIG. 8 is a diagram illustrating, in a cell of the water electrolysis device illustrated in FIG. 1 and that is equipped with a gasket device according to a second embodiment of the present disclosure, the separator and the gasket device.

FIG. 9 is a partial perspective view illustrating a portion of the gasket device illustrated in FIG. 8.

FIG. 10 is a plan view of a spacer in the gasket device illustrated in FIG. 9.

FIG. 11 is a plan view of the gasket in the gasket device illustrated in FIG. 9.

FIG. 12 is a partial perspective view illustrating a portion of a modification example of the gasket device according to the second embodiment of the present disclosure.

FIG. 13 is a partial cross-sectional view illustrating an outline of another example of the configuration of a cell of the water electrolysis device, which is an application target of the gasket devices according to the first and second embodiments of the present disclosure.

### DETAILED DESCRIPTION

Description will be made below on embodiments of the present disclosure with reference to the drawings.

The gasket device according to the present disclosure is a gasket device for sealing a space between opposed members. The opposed members are, for example, a separator and an electrolyte membrane that are used in a cell of a hydrogen generator, a fuel battery, or the like. As an example, the gasket device according to the embodiment of the present disclosure may be for the purpose of sealing a space between opposed separator and electrolyte membrane in a cell of a water electrolysis device of a hydrogen generator. It should be noted that an application target of the gasket device according to the present disclosure is not limited to the above and includes other application targets.

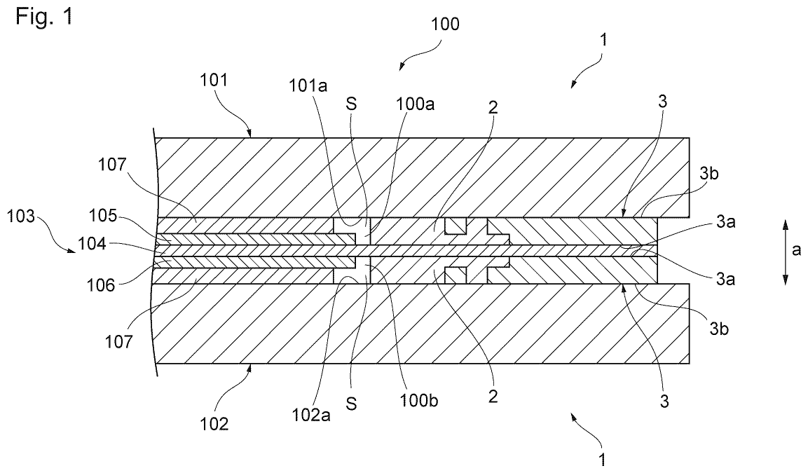

FIG. 1 is a partial cross-sectional view illustrating an outline of a configuration of a cell of a water electrolysis device, which is an application target of a gasket device 1 according to a first embodiment of the present disclosure. As illustrated in FIG. 1, the respective gasket devices 1 are provided in a cell 100 between a separator 101 and an electrolyte membrane 104 of a membrane assembly 103 and between a separator 102 and the electrolyte membrane 104 of the membrane assembly 103, sealing a space 100a between the separator 101 and the electrolyte membrane 104 and a space 100b between the separator 102 and the electrolyte membrane 104. The membrane assembly 103 includes the electrolyte membrane 104 and a pair of catalyst layers, a catalyst 105 and a catalyst 106, provided on respective opposite surfaces of the electrolyte membrane 104. The electrolyte membrane 104 is, for example, an ion exchange membrane, specifically, for example, a solid polymer membrane. A gas diffusion layer 107 is provided on a surface of each of the catalyst 105 and the catalyst 106. Each of the catalyst layers 105, 106 and the gas diffusion layer 107 are surrounded by the gasket device 1, being present in a space to be sealed S sealed by the gasket device 1.

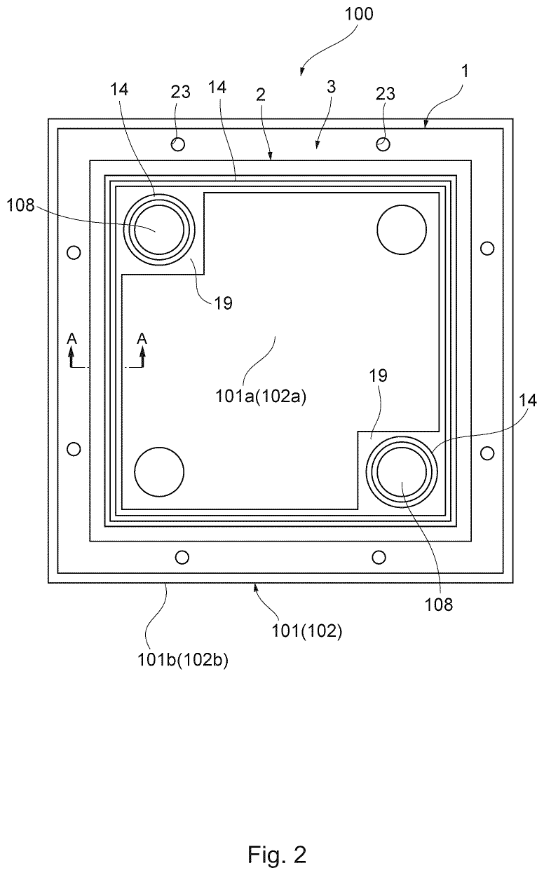

FIG. 2 is a diagram illustrating the separator 101 or 102 and the gasket device 1 in the cell 100. In other words, FIG. 2 is a diagram illustrating, in plan view, the cell 100 in FIG. 1 from which one of the separator 101 and the separator 102, the membrane assembly 103, and the gasket device 1 therebetween are removed. As illustrated in FIG. 2, the gasket device 1 is provided along an outer edge (an outer peripheral edge 101b or 102b) of the separator 101 or 102.

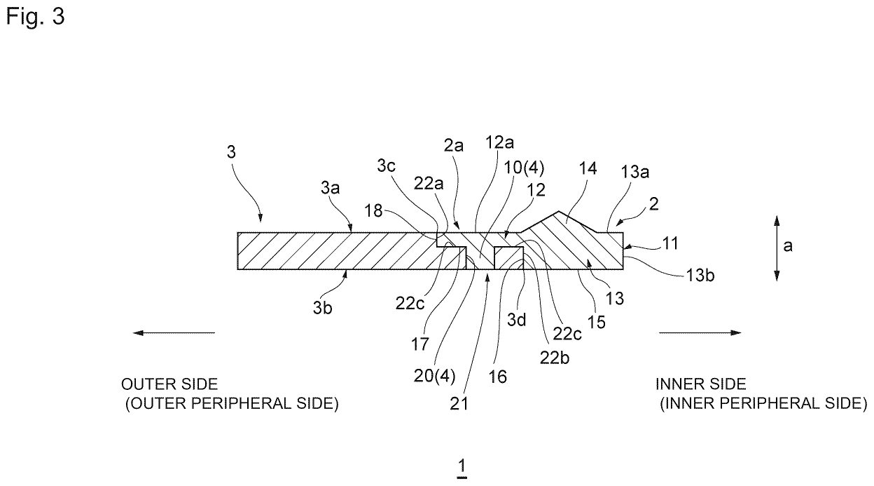

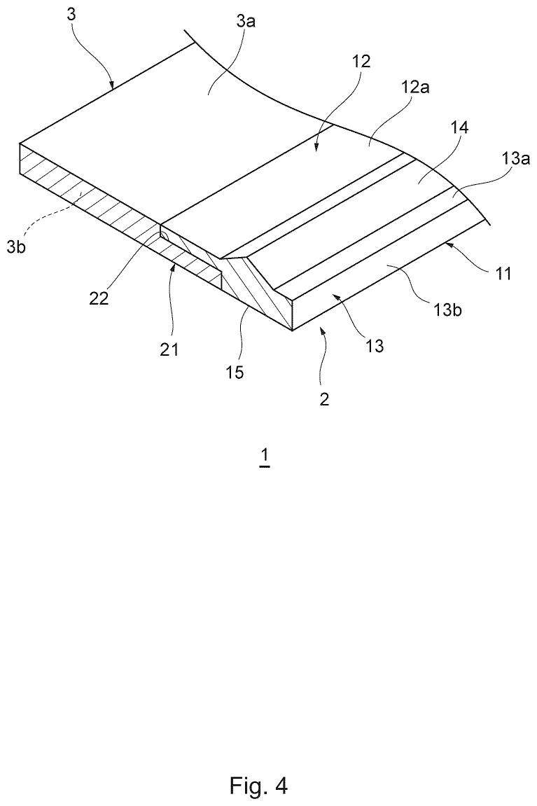

FIG. 3 is a cross-sectional view illustrating a cross section perpendicular to an extending direction of the gasket device land a cross section along a line A-A in FIG. 2. Moreover, FIG. 4 is a partial perspective view illustrating a portion of the gasket device 1. The gasket device 1 includes a gasket 2 made of an elastic body and a spacer 3, which is a member with rigidity. The spacer 3 is a member for supporting, between the separator 101 or the separator 102 and the electrolyte membrane 104, the separator 101 or the separator 102 and the electrolyte membrane 104 in a manner such that the separator 101 or the separator 102 and the electrolyte membrane 104, which are the opposed members, are opposed with the space 100a or the space 100b in between. The gasket 2 is configured to surround substantially the whole of the space 100a or the space 100b between the separator 101 or the separator 102 and the electrolyte membrane 104. The spacer 3 is also configured to surround the gasket 2 from an outer side or an inner side between the separator 101 or the separator 102 and the electrolyte membrane 104. The gasket 2 and the spacer 3 are configured to come into contact with each other in a stretching direction of the space 100a or the space 100b. The configuration of the gasket device 1 will be specifically described below.

As illustrated in FIGS. 3 and 4, the gasket 2 and the spacer 3 include, for example, at a portion where the gasket 2 and the spacer 3 come into contact with each other, an engagement portion 4 that engages the gasket 2 and the spacer 3 with each other. The engagement portion 4 includes a recessed portion 20, which is a portion that is recessed, and a received portion 10, which is a portion to be received in the recessed portion 20. The spacer 3 includes one of at least one recessed portion 20 and at least one received portion 10 on a side of the gasket 2 in the stretching direction of the space 100a or 100b, whereas the gasket 2 includes the other of at least one recessed portion 20 and at least one received portion 10 on a side of the spacer 3 in the stretching direction of the space 100a or 100b. As described above, the spacer 3 surrounds the gasket 2 from the outer side or the inner side, the side of the spacer 3 in the stretching direction of the space 100a or 100b relative to the gasket 2 is the outer side or the inner side, and the side of the gasket 2 in the stretching direction of the space 100a or 100b relative to the spacer 3 is the inner side or the outer side. It should be noted that the stretching direction of the space 100a or 100b refers to a direction intersecting a direction in which the separator 101 or 102 and the electrolyte membrane 104 are opposed, for example, a direction perpendicular to a direction in which the separator 101 or 102 and the electrolyte membrane 104 are opposed. Moreover, the inner side (an inner peripheral side) refers to, in the stretching direction of the space 100a or 100b, a side of the space surrounded by the gasket 2 itself between the separator 101 or 102 and the electrolyte membrane 104. In contrast, the outer side (an outer peripheral side) refers to, in the stretching direction of the space 100a or 100b, the side opposite to the side of the space surrounded by the gasket 2 itself between the separator 101 or 102 and the electrolyte membrane 104.

In the present embodiment, the spacer 3 is configured to surround the gasket 2 from the outer side as illustrated in FIGS. 1 to 3. A space surrounded by the gasket 2 itself between the separator 101 or the separator 102 and the electrolyte membrane 104, in other words, a space on the inner side of the gasket 2, corresponds to a space to be sealed S. Consequently, in the above-described cell 100, the gasket 2 is subject to a high pressure from the inner side and the spacer 3 surrounds the gasket 2 from the outer side opposite the inner side subject to the high pressure. Moreover, the spacer 3 includes at least one recessed portion 20 at a portion at an end on the inner side (an inner peripheral end portion 21) and the gasket 2 includes at least one received portion 10 at a portion at an end on the outer side (an outer peripheral end portion 2a). The recessed portion 20 of the spacer 3 is recessed in an opposed direction (an arrow-a direction in FIG. 1), which is a direction in which the separator 101 or 102 and the electrolyte membrane 104 are opposed, and the received portion 10 of the gasket 2 extends in the opposed direction.

It should be noted that the spacer 3 may be configured to surround the gasket 2 from the inner side. In this case, a space on the outer side of the space surrounded by the gasket 2 itself between the separator 101 or the separator 102 and the electrolyte membrane 104 (the space on the inner side of the gasket 2) corresponds to the space to be sealed S. Consequently, in the cell 100, the gasket 2 is subject to a high pressure from the outer side and the spacer 3 surrounds the gasket 2 from the inner side opposite the outer side subject to the high pressure in this case. Moreover, in this case, the spacer 3 includes at least one recessed portion 20 at the portion at the end on the outer side and the gasket 2 includes at least one received portion 10 at the portion at the end on the inner side. The gasket device 1 in which the spacer 3 is configured to surround the gasket 2 from the inner side has a configuration in which the inner side and the outer side are reversed as compared with the gasket device 1 in which the spacer 3 is configured to surround the gasket 2 from the outer side. A description on the configuration of the gasket device 1 in which the spacer 3 is configured to surround the gasket 2 from the inner side will be provided by switching the inner side and the outer side in the description on the configuration of the gasket 1 in which the spacer 3 is configured to surround the gasket 2 from the outer side. Accordingly, a detailed description on the configuration on the gasket device 1 in which the spacer 3 is configured to surround the gasket 2 from the inner side is omitted.

The gasket 2 annularly extends and has a shape designed to surround a space inside, forming the space to be sealed S as illustrated in FIG. 2. Moreover, the spacer 3 annularly extends and has a shape designed to surround the gasket 2 inside as illustrated in FIG. 2. The spacer 3 is also formed to extend along an edge of an outer periphery (an outer peripheral edge 101b or 102b) of the separator 101 or 102. Moreover, a portion on the outer peripheral side of the gasket 2 and a portion on the inner peripheral side of the spacer 3 are in contact with each other and the gasket 2 and the spacer 3 are engaged with each other at the contact portion.

Specifically, for example, the spacer 3 has, at a portion excluding a stepped portion 22 described later, a constant or substantially constant thickness throughout that portion in the extending direction as illustrated in FIG. 3. Specifically, for example, the spacer 3 also has a constant or substantially constant width throughout the spacer 3 in the extending direction. It should be noted that the extending direction of the spacer 3 refers to a direction in which the spacer 3 extends and also a direction along the outer peripheral edge 101b or 102b of the separator 101 or 102. The thickness of the spacer 3 corresponds to a width in the opposed direction of the spacer 3 and also a distance between a surface 3a and a surface 3b of the spacer 3. The surfaces 3a, 3b of the spacer 3 are surfaces of the spacer 3 facing the respective opposed directions, and the surface 3a is a surface on a side of the electrolyte membrane 104 and the surface 3b is a surface on a side of the separator 101 or 102 as illustrated in FIG. 1. The surface 3a and the surface 3b extend, for example, in parallel or substantially in parallel with each other. Moreover, the width of the spacer 3 refers to a width of the spacer 3 in a direction perpendicular to the extending direction of the spacer 3 in the stretching direction of the space 100a or 100b. It should be noted that the stretching direction of the space 100a or 100b is a direction in which the space 100a or 100b stretches and also a direction along a surface 101a or 102a of the separator 101 or 102.

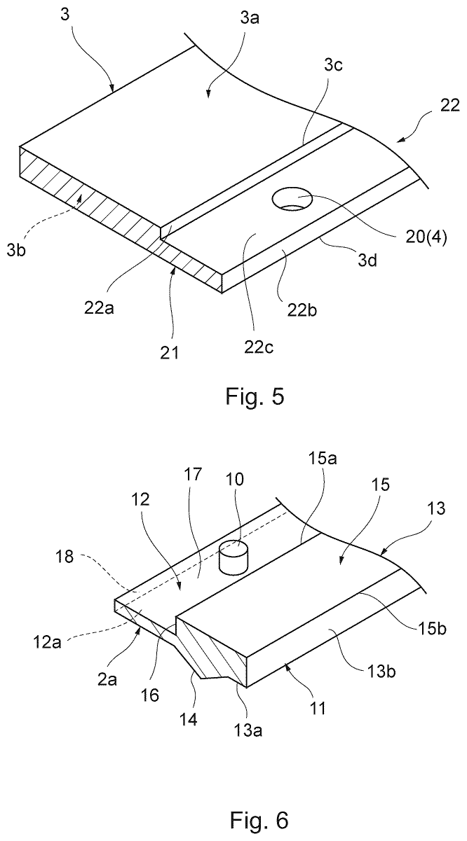

FIG. 5 is a partial perspective view illustrating a portion of the spacer 3. For example, the inner peripheral end portion 21 of the spacer 3 is formed with the stepped portion 22 as illustrated in FIGS. 3 to 5. The stepped portion 22 forms a step in the opposed direction. Specifically, for example, the stepped portion 22 has an outer step surface (a first step surface) 22a, which is a surface facing the side of the gasket 2 or inner side, and an inner step surface (a second step surface) 22b, which is a surface facing the inner side located farther on the inner side than the outer step surface 22. The outer step surface 22a extends from an edge on the inner side (an inner peripheral edge 3c) of the surface 3a of the spacer 3 and the inner step surface 22b extends from an edge on the inner side (an inner peripheral edge 3d) of the surface 3b of the spacer 3. The outer step surface 22a annularly extends and, for example, extends in parallel or substantially in parallel with the opposed direction in cross section as illustrated in FIG. 3. The inner step surface 22b annularly extends and, for example, extends in parallel or substantially in parallel with the opposed direction in cross section as illustrated in FIG. 3. The stepped portion 22 also has a connecting step surface 22c connecting the outer step surface 22a and the inner step surface 22b. The connecting step surface 22c faces a direction toward the electrolyte membrane 104 in the opposed direction and, for example, extends in parallel or substantially in parallel with the surface 3a or 3b.

The recessed portion 20 of the spacer 3 is recessed in the opposed direction. Specifically, for example, the recessed portion 20 is formed in the connecting step surface 22c of the stepped portion 22 of the spacer 3 and recessed inward from the connecting step surface 22c as illustrated in FIGS. 3 and 5. The recessed portion 20 is, for example, a through hole penetrating between the connecting step surface 22c and the surface 3b. It should be noted that the recessed portion 20 does not have to penetrate between the connecting step surface 22c and the surface 3b. As illustrated in FIG. 3, a dimension of the recessed portion 20 in a width direction of the spacer 3 (a right-left direction in FIG. 3) is smaller than a dimension of the connecting step surface 22c in the width direction of the spacer 3. Moreover, the dimension of the recessed portion 20 in the extending direction of the spacer 3 is, for example, the same or substantially the same as the dimension of the recessed portion 20 in the width direction of the spacer 3. It should be noted that the dimension of the recessed portion 20 in the extending direction of the spacer 3 does not have to be the same as the dimension of the recessed portion 20 in the width direction of the spacer 3. A shape (a cross-sectional shape) of the recessed portion 20 in a cross section perpendicular to the opposed direction is, for example, a circular shape or a substantially circular shape. The cross-sectional shape of the recessed portion 20 is not limited to the above and may be any other shape such as a rectangular shape or a triangular shape. The connecting step surface 22c of the spacer 3 is provided with a plurality of recessed portions 20 at an interval. For example, the plurality of recessed portions 20 are arranged at regular intervals or substantially at regular intervals.

It should be noted that the spacer 3 does not have to be in an endless annular shape as described above and a plurality of spacers 3 may be annularly arranged side by side in use. For example, the spacer 3 may have an end and extend along a side of the outer peripheral edge 101b or 102b of the separator 101 or 102. The spacer 3 may also be formed with a locking portion 23 for positioning relative to the separator 101 or 102 as illustrated in FIG. 2. The locking portion 23 is, for example, a recessed portion or a projecting portion and is configured to be locked with a projecting portion or a recessed portion (not illustrated) formed in the separator 101 or 102. The locking portion 23 is, for example, a through hole.

Specifically, for example, the gasket 2 has a constant or substantially constant width throughout most of the gasket 2 in the extending direction as illustrated in FIG. 3. It should be noted that the extending direction of the gasket 2 refers to a direction in which the gasket 2 extends and also refers to a direction along the outer peripheral edge 101b or 102b of the separator 101 or 102. The width of the gasket 2 refers to a width of the gasket 2 in a direction perpendicular to the extending direction of the gasket 2 in the stretching direction of the space 100a or 100b. Moreover, in order to seal the space to be sealed S with respect to a flow path through which pure water is to be guided into the space to be sealed S of the cell 100 or a flow path (a flow path 108) through which hydrogen and oxygen generated from the space to be sealed S of the cell 100 are to be derived, the gasket 2 also includes, for example, a flow path sealing portion 19, which is a portion surrounding the flow path 108 as illustrated in FIG. 2.

FIG. 6 is a partial perspective view illustrating a portion of the gasket 2 and is also a perspective view of the gasket 2 as seen from the side opposite to that in FIG. 4. It should be noted that the portion of the gasket 2 illustrated in FIG. 6 does not include the flow path sealing portion 19. As illustrated in FIGS. 3, 4, and 6, the gasket 2 includes, for example, a sealing portion 11 and a connecting portion 12. The sealing portion 11 is a portion mainly for sealing the space 100a or 100b and the connecting portion 12 is a portion mainly for engaging the gasket 2 with the spacer 3.

As illustrated in FIGS. 3, 4, and 6, the sealing portion 11 extends in the extending direction of the gasket 2 and includes a base portion 13 and a seal bead portion 14. A shape of a cross section of the base portion 13 perpendicular to the extending direction is, for example, a rectangular shape or a substantial rectangular shape and the base portion 13 has a sealing surface 15 and a surface (a surface 13a) facing away from the sealing surface 15 in the opposed direction. The sealing surface 15, which is a surface of the base portion 13, is in a form of a flat surface or substantially in a form of a flat surface as illustrated in FIGS. 3 and 6 and is configured to, in the cell 100, come continuously into contact with the surface 101a or 102a of the separator 101 or 102 in the extending direction of the base portion 13. The seal bead portion 14 is a seal bead configured to, in the cell 100, come into contact with the electrolyte membrane 104 and projects from the surface 13a of the base portion 13. A shape of a cross section of the seal bead portion 14 perpendicular to the extending direction of the gasket 2 is a wedged shape as illustrated in, for example, FIG. 3. It should be noted that the shape of the seal bead portion 14 is not limited to a wedged shape and may be any other shape. Although the seal bead portion 14 is located farther on the outer side than the surface 13a in the illustrated example, the seal bead portion 14 may be located in a middle of the surface 13a or farther on the inner side than the surface 13a.

As illustrated in FIGS. 3 and 6, a contact surface 16 extends from an end on the outer side (an end 15a) of the sealing surface 15. The contact surface 16 is a surface extending toward a side of the seal bead portion 14 and is also a surface of the base portion 13 extending in the extending direction. The contact surface 16 is in a shape designed to come into contact with the inner step surface 22b of the stepped portion 22 of the spacer 3. Moreover, a side surface 13b, which is a surface facing away from the contact surface 16, extends from an end on the inner side (an end 15b) of the sealing surface 15 and the side surface 13b is continuous with the surface 13a.

The connecting portion 12 is a portion extending outward from the base portion 13 as illustrated in FIGS. 3, 4, and 6. The connecting portion 12, a shape of which in a cross section perpendicular to the extending direction is, for example, a rectangular shape or a substantially rectangular shape, has a surface 12a, a contact surface 17, and a contact surface 18. The contact surface 17 is a surface extending toward the outer side from an end of the contact surface 16 of the base portion 13 and is in a shape designed to come into contact with the connecting step surface 22c of the stepped portion 22 of the spacer 3. The surface 12a is a surface facing away from the contact surface 17 in the opposed direction. The contact surface 18 is a surface extending between the contact surface 17 and the surface 12a and facing outward and is in a shape designed to come into contact with the outer step surface 22a of the stepped portion 22 of the spacer 3.

The connecting portion 12 and the contact surface 16 of the base portion 13 constitute the outer peripheral end portion 2a of the gasket 2 and the outer peripheral end portion 2a is configured to, at least in a later-described in-use state, come into contact with the outer step surface 22a and the inner step surface 22b of the stepped portion 22 of the spacer 3. Moreover, the connecting portion 12, which constitutes the outer peripheral end portion 2a of the gasket 2, is provided with the received portion 10. Specifically, the received portion 10 is provided on the contact surface 17 of the connecting portion 12 and the received portion 10 projects from the contact surface 17 as illustrated in FIG. 6. The received portion 10, which is in a shape designed to be received in the recessed portion 20 of the spacer 3 as described above, has a columnar shape extending in the opposed direction as illustrated in, for example, FIG. 6 and a shape of the received portion 10 in a cross section perpendicular to the extending direction (the opposed direction) is, for example, a circular shape or a substantially circular shape. Moreover, the received portion 10 is in a form designed to be received in the recessed portion 20 by press fit. It should be noted that the received portion 10 may be in a form designed to be received in the recessed portion 20 by transition fit or the in a form designed to be received in the recessed portion 20 by clearance fit. Moreover, the cross-sectional shape of the received portion 10 is not limited to a circular shape or a substantially circular shape.

The surface 12a of the connecting portion 12 and the surface 13a of the sealing portion 11 are located within the same plane or substantially the same planes. Specifically, for example, a position of the surface 12a of the connecting portion 12 and a position of the surface 13a of the sealing portion 11 in the opposed direction are the same or substantially the same. Moreover, the seal bead portion 14 is in a form such that in the gasket device 1 in an assembled state in which the gasket 2 and the spacer 3 are assembled, the seal bead portion 14 projects further toward the electrolyte membrane 104 side in the opposed direction (an electrode side, an upper side in FIG. 3) than the surface 3a of the spacer 3. Moreover, the surface 12a of the connecting portion 12 of the gasket 2 is in a form such that in the gasket device 1 in the assembled state, the surface 12a does not project toward the electrode side from the surface 3a of the spacer 3 in the opposed direction. In other words, in the gasket device 1 in the assembled state, a position of the surface 12a of the connecting portion 12 of the gasket 2 in the opposed direction is the same as a position of the surface 3a of the spacer 3 in the opposed direction or on a separator side with respect to the position of the surface 3a of the spacer 3 in the opposed direction. It should be noted that the separator side refers to a side on which the gasket device 1 faces the separator 101 or the separator 102, with which the gasket device 1 is to come into contact, in the opposed direction and, in FIG. 3, the lower side. Moreover, in the gasket device 1 in the assembled state, the sealing surface 15 of the sealing portion 11 of the gasket 2 and the surface 3b of the spacer 3 are located within the same plane or substantially the same planes. Specifically, for example, a position of the sealing surface 15 and a position of the surface 3b of the spacer 3 are equal or substantially equal in the opposed direction.

As illustrated in, for example, FIG. 2, the flow path sealing portion 19 of the gasket 2 is formed by the sealing surface 15 of the sealing portion 11 and the surface 13a extending in such a manner as to cover the flow path 108 and the surface 13a of the flow path sealing portion 19 is formed with the seal bead portion 14 annularly extending around the flow path 108. It should be noted that the seal bead portion 14 of the flow path sealing portion 19 of the gasket 2 does not necessarily annularly extend around the flow path 108. For example, the seal bead portion 14 of the flow path sealing portion 19 may be connected to the seal bead portion 14 of the sealing portion 11, surrounding the flow path 108 in combination with the seal bead portion 14 of the sealing portion 11.

As described above, the gasket 2 includes the sealing portion 11, the connecting portion 12, and the flow path sealing portion 19 and the sealing portion 11 and the flow path sealing portion 19 include the base portion 13 and the seal bead portion 14. These portions are portions of the gasket 2 that are integrally formed from the same material and integrated. The elastic body of the gasket 2 is, for example, rubber or the like. Specifically, for example, fluororubber (FKM), ethylene propylene diene rubber (EPDM), silicone rubber (VMQ), and the like are usable as the elastic body of the gasket 2. In contrast, the spacer 3 is a member with rigidity and a material of the spacer 3 is, for example, metal or resin. The material of spacer 3 is specifically, for example, SUS, Al, Ti, or the like, or polyphenylene sulfide (PPS), glass epoxy resin, or the like.

As described above, the contact surface 16 of the base portion 13 of the gasket 2 is in the shape designed to come into contact with the inner step surface 22b of the stepped portion 22 of the spacer 3, the contact surfaces 17, 18 of the connecting portion 12 of the gasket 2 are in the shapes designed to come into contact with the connecting step surface 22c and the outer step surface 22a of the stepped portion 22 of the spacer 3, respectively, and the connecting portion 12 is in the shape corresponding to that of the stepped portion 22.

The gasket device 1 is to be used in the assembled state in which the gasket 2 and the spacer 3 are assembled as illustrated in FIGS. 3 and 4. Specifically, the gasket device 1 is put into the assembled state by engaging the engagement portion 4 (the received portion 10 and the recessed portion 20) to connect the connecting portion 12 of the gasket 2 and the stepped portion 22 of the spacer 3 to each other. In the gasket device 1 in the assembled state, the received portion 10 of the gasket 2 is received in the recessed portion 20 of the corresponding spacer 3 and the engagement portion 4 is engaged. Moreover, in the gasket device 1 in the assembled state, the contact surface 17 of the connecting portion 12 of the gasket 2 and the connecting step surface 22c of the stepped portion 22 of the spacer 3 are in contact with each other.

In the gasket device 1 in the assembled state, the contact surface 16 of the sealing portion 11 of the gasket 2 may be configured to come into contact with the inner step surface 22b of the stepped portion 22 of the spacer 3 or may be configured to face the inner step surface 22b with a space in between without contact. Even in a case where the contact surface 16 of the sealing portion 11 faces the inner step surface 22b of the stepped portion 22 with the space in between without contact in the gasket device 1 in the assembled state, the contact surface 16 of the sealing portion 11 and the inner step surface 22b of the stepped portion 22 are configured to come into contact in the later-described in-use state of the gasket device 1. It should be noted that the contact surface 16 of the sealing portion 11 and the inner step surface 22b of the stepped portion 22 may be configured not to come into contact even in the later-described in-use state of the gasket device 1.

Moreover, in the gasket device 1 in the assembled state, the contact surface 18 of the connecting portion 12 of the gasket 2 may be configured to come into contact with the outer step surface 22a of the stepped portion 22 of the spacer 3 or may be configured to face the outer step surface 22a with a space in between without contact. Even in a case where the contact surface 18 of the connecting portion 12 faces the outer step surface 22a of the stepped portion 22 with the space in between without contact in the gasket device 1 in the assembled state, the contact surface 18 of the connecting portion 12 and the outer step surface 22a of the stepped portion 22 are configured to come into contact in the later-described in-use state of the gasket device 1. It should be noted that the contact surface 18 of the connecting portion 12 and the outer step surface 22a of the stepped portion 22 may be configured not to come into contact even in the later-described in-use state of the gasket device 1.

Next, description will be made on workings of the gasket device 1 having the above-described configuration. As illustrated in FIG. 1, the gasket device 1 is provided in the cell 100 of a water splitting device between the separator 101 or 102 and the electrolyte membrane 104 to seal the space 100a or 100b. In the in-use state in which the gasket device 1 is attached to the cell 100, the spacer 3 is sandwiched between the separator 101 or 102 and the electrolyte membrane 104 in the opposed direction to retain the separator 101 or 102 and the electrolyte membrane 104 in an opposed state at a certain distance. Moreover, the sealing portion 11 of the gasket 2 is sandwiched between the separator 101 or 102 and the electrolyte membrane 104 in the opposed direction and compressed in the opposed direction. The gasket 2 thus performs sealing between the separator 101 or 102 and the electrolyte membrane 104. The gasket devices 1 are similarly provided between the separator 101 and the electrolyte membrane 104 and between the separator 102 and the electrolyte membrane 104 and similarly work. Accordingly, a specific description will be made below on workings of the gasket device 1 between the separator 101 and the electrolyte membrane 104.

Between the separator 101 and the electrolyte membrane 104, the surface 3b of the spacer 3 is in contact with the surface 101a of the separator 101 along the outer peripheral edge 101b of the separator 101 and the surface 3a of the spacer 3 is in contact with a surface of the electrolyte membrane 104 along the outer peripheral edge of the electrolyte membrane 104. The separator 101 and the electrolyte membrane 104 are thus retained in the opposed state at the certain distance.

Moreover, between the separator 101 and the electrolyte membrane 104, which are supported by the spacer 3, the gasket 2 is compressed in the opposed direction with the seal bead portion 14 of the gasket 2 being in contact with the surface of the electrolyte membrane 104 along the spacer 3 and the sealing surface 15 of the base portion 13 of the gasket 2 being in contact with the surface 101a of the separator 101 along the spacer 3. Sealing between the separator 101 and the electrolyte membrane 104 is thus performed along the outer peripheral edge 101b of the separator 101. Moreover, the gasket 2 is also compressed in the opposed direction at the flow path sealing portion 19 with the seal bead portion 14 of the flow path sealing portion 19 being in contact with the surface of the electrolyte membrane 104 while surrounding the flow path 108 and the sealing surface 15 of the flow path sealing portion 19 being in contact with the surface 101a of the separator 101 while surrounding the flow path 108. Sealing between the separator 101 and the electrolyte membrane 104 is thus also performed around the flow path 108. It should be noted that in the cell 100, the gasket device 1 may be used in an attitude in which the seal bead portion 14 of the gasket 2 is in contact with the separator 101 and the sealing surface 15 of the gasket 2 is in contact with the electrolyte membrane 104.

As described above, in the in-use state, the contact surface 16 of the sealing portion 11 of the gasket 2 is in contact with the inner step surface 22b of the stepped portion 22 of the spacer 3 (see FIG. 3). Moreover, the contact surface 18 of the connecting portion 12 of the gasket 2 is in contact with the outer step surface 22a of the stepped portion 22 of the spacer 3 (see FIG. 3). Consequently, when the pressure of the space to be sealed S becomes high, the gasket 2 is pressed to a spacer 3 side, expanding in the opposed direction. This causes a surface pressure of the contact surface between the seal bead portion 14 and the surface of the electrolyte membrane 104 to further increase and, likewise, a surface pressure of the contact surface between the sealing surface 15 and the surface 101a of the separator 101 to further increase. Consequently, the sealing performance of the gasket 2 is enhanced. As seen from the above, the gasket 2 is configured to exert a self-sealing action in the gasket device 1.

Meanwhile, since the gasket 2 is compressed in the opposed direction in the in-use state as described above, the gasket 2 is thus deformed in such a manner as to expand in the stretching direction of the space 100a. Thus, there are cases where in sandwiching the gasket device 1 between the separator 101 and the electrolyte membrane 104, a part of the base portion 13 of the gasket 2 climbs over the inner step surface 22b of the stepped portion 22 of the spacer 3 and, in the in-use state, the part of the base portion 13 of the gasket 2 is caught in between the surface 3b of the spacer 3 and the surface 101a of the separator 101, resulting in so-called biting. Likewise, there are cases where in sandwiching the gasket device 1 between the separator 101 and the electrolyte membrane 104, a part of the connecting portion 12 of the gasket 2 climbs over the outer step surface 22a of the stepped portion 22 of the spacer 3 and, in the in-use state, the part of the connecting portion 12 of the gasket 2 is caught in between the surface 3a of the spacer 3 and the surface of the electrolyte membrane 104, resulting in biting. Accordingly, biting is prevented or reduced by adjusting the shapes of the gasket 2 and the spacer 3 within a range allowing the above-described self-sealing action to be exerted. The shapes to be adjusted specifically include a structure designed to form a relief portion for the deformed gasket 2. Examples of the structure include, in the gasket device 1 in the assembled state, a dimension of a gap between the contact surface 16 of the sealing portion 11 and the inner step surface 22b of the stepped portion 22, a dimension of a gap between the contact surface 18 of the connecting portion 12 and the outer step surface 22a of the stepped portion 22, a dimension of a step in the opposed direction between the surface 3a of the spacer 3 and the surface 12a of the connecting portion 12, and a dimension of a step in the opposed direction between the surface 3b of the spacer 3 and the sealing surface 15 of the base portion 13. Any one, any combination, or all of the above structures are adjusted so that the gasket device 1 is configured to exert the self-sealing action without the occurrence of biting. It should be noted that the gasket device 1 does not have to be configured to exert the self-sealing action and biting does not have to be prevented or reduced.

In the cell 100, the gasket 2 is located on the inner side of the spacer 3 and is adjacent to the space to be sealed S as illustrated in FIGS. 1 and 2. Moreover, in the gasket device 1 in the in-use state, the contact surface 16 of the sealing portion 11 of the gasket 2 is in contact with the inner step surface 22b of the stepped portion 22 of the spacer 3 and the contact surface 18 of the connecting portion 12 of the gasket 2 is in contact with the outer step surface 22a of the stepped portion 22 of the spacer 3. As seen from the above, in the gasket device 1 in the in-use state, the gasket 2 is supported from the outer side in the stretching direction of the space 100a by the spacer 3. The gasket 2 is thus supported from the outer side in the stretching direction of the space 100a by the spacer 3 even though the pressure within the space to be sealed S becomes high and a force toward the outer side in the stretching direction of the space 100a is applied to the gasket 2. Therefore, it is possible to prevent a deformation or a shift of the gasket 2 and a reduction in the sealing performance of the gasket 2 and also prevent the gasket 2 from being detached from the cell 100. It should be noted that in a case where the contact surface 16 of the gasket 2 is not in contact with the inner step surface 22b of the spacer 3 in the in-use state, the gasket 2 is also supported by the spacer 3 as described above. Insofar as, for example, the gap between the contact surface 16 and the inner step surface 22b is slight, the gasket 2 is supported in the stretching direction of the space 100a by the spacer 3 after slightly shifted or deformed, even though the pressure within the space to be sealed S becomes high and a force toward the outer side in the stretching direction of the space 100a is applied to the gasket 2. The same applies to the outer step surface 22a of the contact surface 18.

Moreover, when the pressure within the space to be sealed S becomes high, the gasket device 1 exerts the self-sealing action of the gasket 2, which results in an increase in the surface pressures of the gasket 2 relative to the separator 101 and the electrolyte membrane 104 as described above. Therefore, even though the pressure within the space to be sealed S becomes high and a force toward the outer side in the stretching direction of the space 100a is applied to the gasket 2, the increased surface pressures make it possible to prevent or reduce the detachment of the gasket 2 from the cell 100.

Moreover, in the gasket device 1, the gasket 2 is retained in engagement with the spacer 3, which eliminates the necessity of bonding the gasket 2 and the spacer 3 with an adhesive. Moreover, the gasket device 1 has the structure designed to exert the self-sealing action as described above, which eliminates the necessity of bonding the gasket 2 and the spacer 3 with an adhesive for the purpose of improving the sealing performance. Moreover, the gasket 2 is retained in engagement with the spacer 3, which facilitates the replacement of the gasket 2 or the spacer 3. Moreover, the gasket 2 and the spacer 3 are easy to assemble and the gasket device 1 is also easy to install in the cell 100.

As described above, the gasket device 1 according to the first embodiment of the present disclosure is capable of maintaining the sealing performance even through the pressure of the space to be sealed S becomes high.

It should be noted that even though the spacer 3 is configured to surround the gasket 2 from the inner side, the gasket device 1 works as the above-described gasket device 1 and produces similar effects.

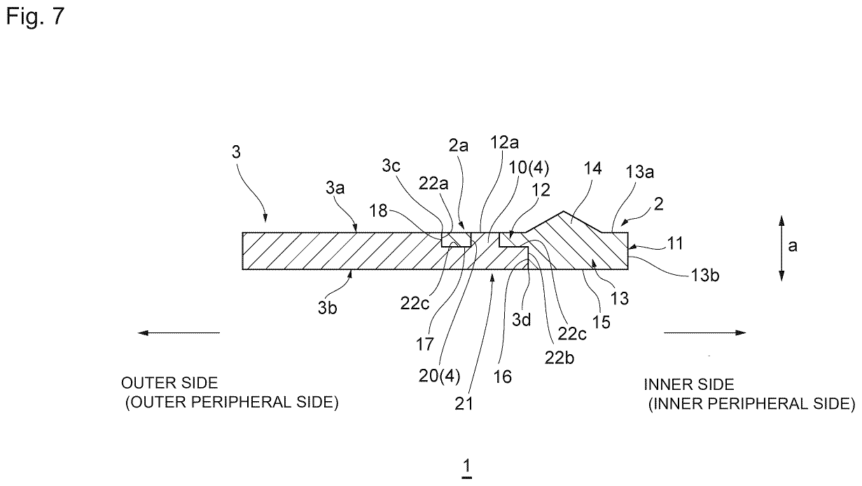

As illustrated in FIG. 7, the gasket 2 may include the recessed portion 20 in place of the received portion 10 and the spacer 3 may include the received portion 10 in place of the recessed portion 20. In this case, the recessed portion 20 is disposed in the connecting portion 12 of the gasket 2 in a similar manner to the above-described received portion 10 and recessed from the contact surface 17 of the connecting portion 12, penetrating the connecting portion 12. The recessed portion 20 does not have to penetrate the connecting portion 12. The received portion 10 is also disposed in the connecting step surface 22c of the spacer 3 in a similar manner to the above-described recessed portion 20 and projects from the connecting step surface 22c. In this case, the gasket device 1 also works as the above-described gasket device 1 and produces similar effects.

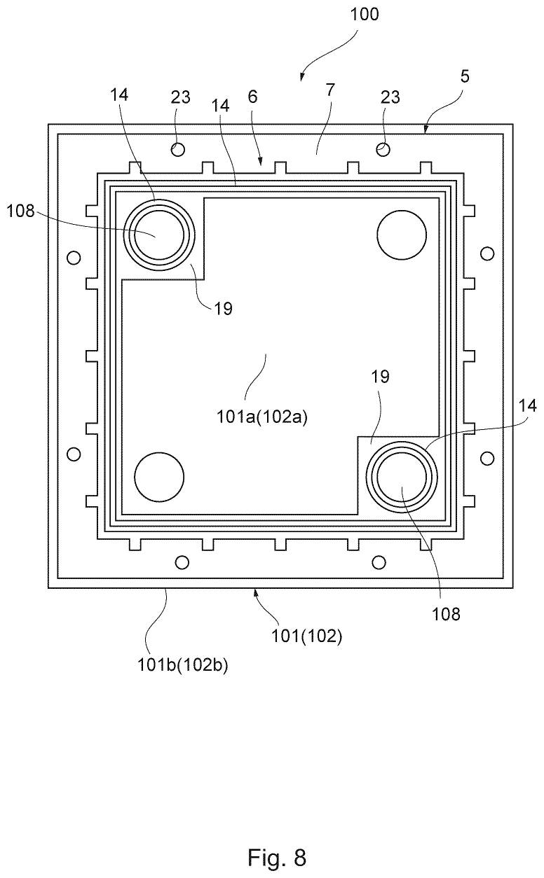

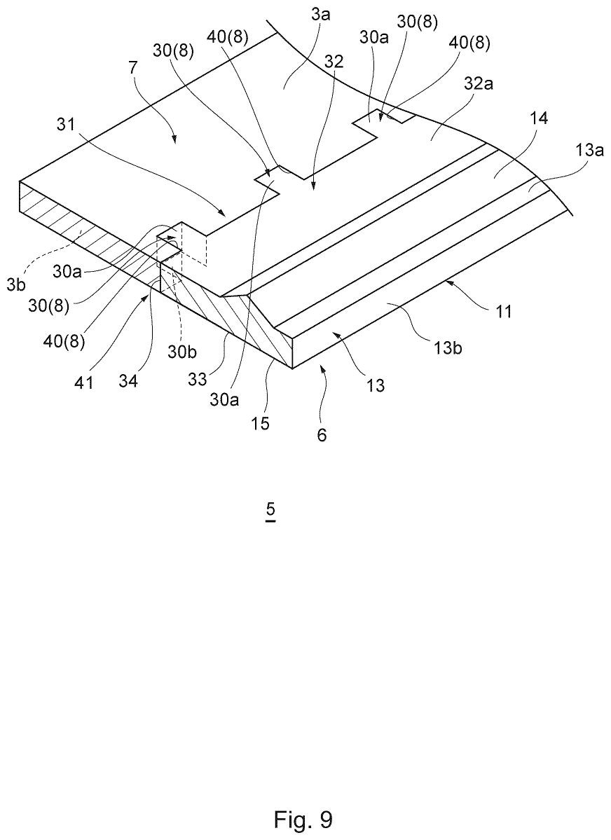

Next, description will be made on a gasket device 5 according to a second embodiment of the present disclosure. FIG. 8 is a diagram illustrating, in the cell 100 of a water electrolysis device of a hydrogen generator and that is equipped with the gasket device 5, the separator 101 or 102 and the gasket device 2. FIG. 9 is a partial perspective view illustrating a portion of the gasket device 5. FIG. 8 corresponds to FIG. 2. The gasket device 5 is different from the above-described gasket device 1 in a contact manner and an engagement manner of the gasket and the spacer. Hereinbelow, out of the components of the gasket device 5, a component that is the same as or has a similar function to that of the above-described gasket device 1 is labelled with the same reference sign and the description thereof is omitted, accordingly, and a description will be made on a component different from that of the gasket device 1.

As illustrated in FIGS. 8 and 9, the gasket device 5 includes a gasket 6 and a spacer 7, which are disposed as the gasket 2 and the spacer 3 of the gasket device 1. In other words, the spacer 7 is configured to surround the gasket 6 from the outer side between the separator 101 or the separator 102 and the electrolyte membrane 104. The gasket 6 and the spacer 7 are also configured to come into contact with each other in the stretching direction of the space 100a or the space 100b. The gasket 6 and the spacer 7 are also configured to be placed in the cell 100 as the gasket 2 and the spacer 3 of the gasket device 1. Moreover, the gasket device 5 has a dimension similar to that of the gasket device 1.

The gasket 6 and the spacer 7 also include an engagement portion 8 corresponding to the engagement portion 4 of the gasket 2 and the spacer 3 of the gasket device 1. The engagement portion 8 includes a recessed portion 40, which is a portion that is recessed, and a received portion 30, which is a portion to be received in the recessed portion 40. The spacer 7 includes at least one recessed portion 40 at a portion at an end on the inner side (an inner peripheral end portion 41) and the gasket 6 includes at least one received portion 30 at a portion at an end on the outer side (an outer peripheral end portion 6a). The recessed portion 40 of the spacer 7 is recessed in the stretching direction of the space 100a or 100b (a direction of space) and the received portion 30 of the gasket 6 extends in the stretching direction of the space 100a or 100b.

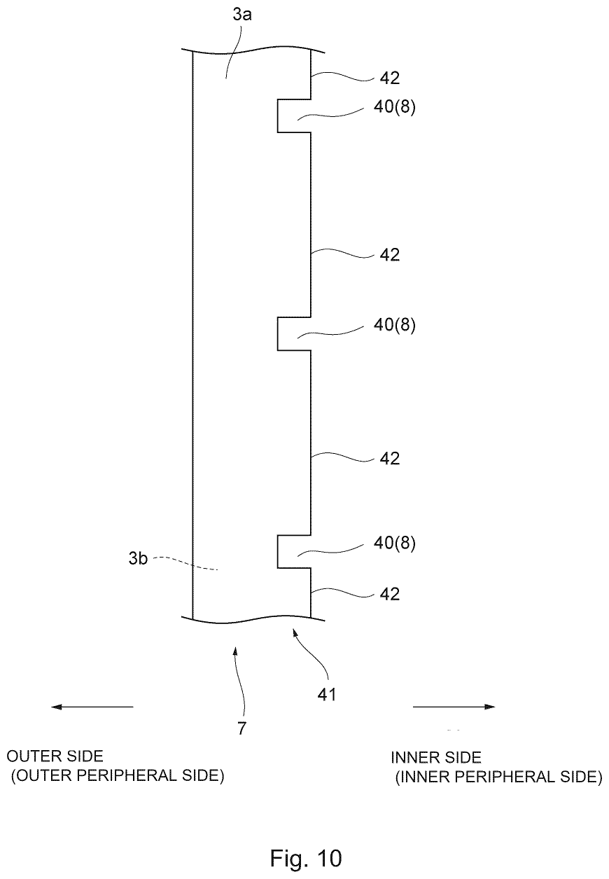

FIG. 10 is a plan view of the spacer 7. As illustrated in FIGS. 9 and 10, the spacer 7 is different from the spacer 3 in that the spacer 7 includes the inner peripheral end portion 41 instead of the inner peripheral end portion 21. The spacer 7 has the surfaces 3a, 3b as the spacer 3. The inner peripheral end portion 41 of the spacer 7 is provided with a plurality of recessed portions 40 arranged side by side in an extending direction of the spacer 7. For example, the plurality of recessed portions 40 are arranged at regular intervals or substantially at regular intervals. The recessed portions 40 are portions recessed from an inner peripheral end surface 42 of the spacer 7 as illustrated in FIG. 10. It should be noted that the inner peripheral end surface 42, which is a surface of the spacer 7 facing the inner side, extends between the surface 3a and the surface 3b and also annularly extends. The recessed portions 40 are recessed portions in a rectangular shape or substantially in a rectangular shape in plan view as illustrated in, for example, FIG. 10. The recessed portions 40 may be in any other shape. Moreover, although the recessed portions 40 penetrate between the surface 3a and the surface 3b, the recessed portions 40 do not have to penetrate between the surface 3a and the surface 3b.

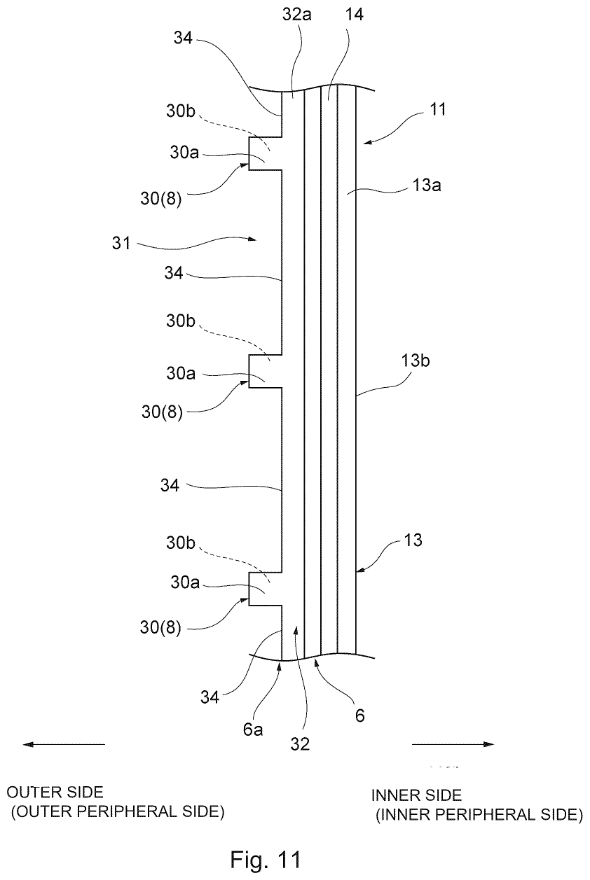

FIG. 11 is a plan view of the gasket 6. As illustrated in FIGS. 9 and 11, the gasket 6 is different from the gasket 2 in that the gasket 6 includes a connecting portion 31 instead of the connecting portion 12. The gasket 6 includes the sealing portion 11 as the gasket 2. As illustrated in FIGS. 9 and 11, the connecting portion 31 includes a base portion 32, which is a portion formed by the base portion 13 of the sealing portion 11 extending outward. The base portion 32 has a sealing surface 33, which is a surface formed by the sealing surface 15 of the base portion 13 extending, and a surface 32a, which is a surface of the base portion 32 facing away from the sealing surface 33 in the opposed direction. The base portion 32 also has a contact surface 34, which is a surface facing the outer side and extending between the sealing surface 33 and the surface 32a.

The outer peripheral end portion 6a of the gasket 6 is an end portion on the outer peripheral side of the connecting portion 31 and the received portion 30 is provided in the outer peripheral end portion 6a of the connecting portion 31. Specifically, the received portion 30 is formed in the contact surface 34 and projects outward from the contact surface 34 as illustrated in FIGS. 9 and 11. The contact surface 34 is provided with a plurality of received portions 30 arranged side by side in an extending direction of the gasket 6. For example, the plurality of received portions 30 are arranged at regular intervals or substantially at regular intervals. The received portions 30 are in a shape able to be received in the recessed portions 40 as the received portions 10. The received portions 30 are in a shape corresponding to that of the recessed portions 40, for example, in a rectangular shape or substantially in a rectangular shape in plan view. The received portions 30 may be in any other shape. Moreover, as illustrated in FIG. 9, surfaces 30a, 30b of each of the received portions 30, which face away in the opposed direction, are flush or substantially flush with the surface 32a of the connecting portion 32 and the sealing surface 33, respectively. It should be noted that the surfaces 30a, 30b of each of the received portions 30 may be continuous with the surface 32a of the connecting portion 32 and the sealing surface 33 with the formation of a step, respectively.

The contact surface 34 is configured to come into contact with the inner peripheral end surface 42 of the spacer 7 when the received portions 30 are received in the recessed portions 40. In the gasket 6, the surface 32a of the base portion 32 of the connecting portion 31 and the surface 13a of the sealing portion 11 are located within the same plane or substantially the same planes. Specifically, for example, a position of the surface 32a of the base portion 32 and a position of the surface 13a of the sealing portion 11 in the opposed direction are the same or substantially the same. Moreover, in the gasket device 5 in an assembled state in which the gasket 6 and the spacer 7 are assembled, the surface 32a of the base portion 32 and the surfaces 30a of the received portions 30 of the gasket 6 are in a form designed not to project on the electrode side from the surface 3a of the spacer 7 in the opposed direction. Moreover, in the gasket device 5 in the assembled state, the sealing surface 15 of the sealing portion 11 and the sealing surface 33 of the base portion 32 of the gasket 6 are located within the plane that is the same or substantially the same as that of the surface 3b of the spacer 7.

As described above, the gasket 6 includes the sealing portion 11, the connecting portion 31, and the flow path sealing portion 19, the sealing portion 11 and the flow path sealing portion 19 include the base portion 13 and the seal bead portion 14, and the connecting portion 31 includes the base portion 32 and the received portion 30. These portions are portions of the gasket 6 that are integrally formed from the same material and integrated. The elastic body of the gasket 6 is, for example, rubber or the like. Specifically, for example, fluororubber (FKM), ethylene propylene diene rubber (EPDM), silicone rubber (VMQ), and the like are usable as the elastic body of the gasket 6. The spacer 7 is a member with rigidity and a material of the spacer 7 is, for example, metal or resin. The material of spacer 7 is specifically, for example, SUS, Al, Ti, or the like, or polyphenylene sulfide (PPS), glass epoxy resin, or the like.

The gasket device 5 is to be used in the assembled state in which the gasket 6 and the spacer 7 are assembled as illustrated in FIGS. 8 and 9. Specifically, the gasket device 5 is put into the assembled state by engaging the engagement portion 8 (the received portion 30 and the recessed portion 40) to connect the connecting portion 31 of the gasket 6 and the inner peripheral end portion 41 of the spacer 7 to each other. In the gasket device 5 in the assembled state, the received portion 30 of the gasket 6 is received in the recessed portion 40 of the corresponding spacer 7 and the engagement portion 8 is engaged. Moreover, in the gasket device 5 in the assembled state, the contact surface 34 of the connecting portion 31 of the gasket 6 and the inner peripheral end surface 42 of the spacer 7 are in contact with each other. In the gasket device 5 in the assembled state, the contact surface 34 of the gasket 6 may be configured to face the inner peripheral end surface 42 of the spacer 7 with a space in between without contact. Even in a case where the contact surface 34 of the gasket 6 faces the inner peripheral end surface 42 of the spacer 7 with the space in between without contact in the gasket device 5 in the assembled state, the contact surface 34 of the gasket 6 and the inner peripheral end surface 42 of the spacer 7 are configured to come into contact in the in-use state of the gasket device 5. It should be noted that the contact surface 34 of the gasket 6 and the inner peripheral end surface 42 of the spacer 7 may be configured not to come into contact even in the in-use state of the gasket device 5.

The gasket device 5 is put into the in-use state when installed in the cell 100 as the gasket device 1. In the in-use state of the gasket device 5, the spacer 7 retains the separator 101 or 102 and the electrolyte membrane 104 in an opposed state at a certain distance as the spacer 3. The gasket 6 also performs sealing between the separator 101 or 102 and the electrolyte membrane 104 as the gasket 2. In the gasket device 5, the gasket 6 is also configured to exert the self-sealing action on the basis of the contact with the spacer 7 as the gasket 2 of the gasket device 1. Moreover, biting is prevented or reduced by adjusting the shapes of the gasket 6 and the spacer 7 within a range allowing the self-sealing action as in the gasket device 1 to be exerted. The shapes to be adjusted specifically include a structure designed to form a relief portion for the expanded gasket 6. Examples of the structure include, in the gasket device 5 in the assembled state, a dimension of a gap between the contact surface 34 of the connecting portion 31 of the gasket 6 and the inner peripheral end surface 42 of the spacer 7, a dimension of a gap between the received portion 30 and the recessed portion 40, a dimension of the step in the opposed direction between the surface 3a of the spacer 6 and the surfaces 30a, 32a of the gasket 6, and a dimension of a step in the opposed direction between the surface 3b of the spacer 6 and the surface 30b and the sealing surfaces 15, 33 of the gasket 6. Any one, any combination, or all of the above structures are adjusted so that the gasket device 5 is configured to exert the self-sealing action without the occurrence of biting. It should be noted that the gasket device 5 does not have to be configured to exert the self-sealing action and biting does not have to be prevented or reduced.

Moreover, in the cell 100, the contact surface 34 of the gasket 6 is in contact with the inner peripheral end surface 42 of the spacer 7 on the outer side of the gasket 6. As seen from the above, in the gasket device 5 in the in-use state, the gasket 6 is supported from the outer side in the stretching direction of the space 100a by the spacer 7 as in the gasket device 1. The gasket 6 is thus supported in the stretching direction of the space 100a by the spacer 7 even though the pressure within the space to be sealed S becomes high and a force toward the outer side in the stretching direction of the space 100a is applied to the gasket 6. Therefore, it is possible to prevent a deformation or a shift of the gasket 6 and a reduction in the sealing performance of the gasket 6 and also prevent the gasket 6 from being detached from the cell 100. It should be noted that in a case where the contact surface 34 of the gasket 6 is not in contact with the inner peripheral end surface 42 of the spacer 7 in the in-use state, the gasket 6 is also supported by the spacer 7 as described above. Insofar as, for example, the gap between the contact surface 34 and the inner peripheral end surface 42 is slight, the gasket 6 is supported in the stretching direction of the space 100a by the spacer 7 after slightly shifted or deformed, even though the pressure within the space to be sealed S becomes high and a force toward the outer side in the stretching direction of the space 100a is applied to the gasket 6.

Moreover, when the pressure within the space to be sealed S becomes high, the gasket device 5 exerts the self-sealing action of the gasket 6, which results in an increase in the surface pressures of the gasket 6 relative to the separator 101 or 102 and the electrolyte membrane 104 as described above. Therefore, even though the pressure within the space to be sealed S becomes high and a force toward the outer side in the stretching direction of the space 100a or 100b is applied to the gasket 6, the increased surface pressures make it possible to prevent or reduce the detachment of the gasket 6 from the cell 100. The gasket device 5 also works in a similar manner to the gasket device 1.

As described above, the gasket device 5 according to the second embodiment of the present disclosure is capable of maintaining the sealing performance even through the pressure of the space to be sealed S becomes high.

It should be noted that the spacer 7 may be configured to surround the gasket 6 from the inner side as the above-described gasket 1. In this case, a space on the outer side of the space surrounded by the gasket 6 itself between the separator 101 or the separator 102 and the electrolyte membrane 104 (the space on the inner side of the gasket 6) corresponds to the space to be sealed S. Consequently, in the cell 100, the gasket 6 is subject to a high pressure from the outer side and the spacer 7 surrounds the gasket 6 from the inner side opposite the outer side subject to the high pressure in this case. Moreover, the spacer 7 includes at least one recessed portion 40 at the portion at the end on the outer side and the gasket 6 includes at least one received portion 30 at the portion at the end on the inner side in this case. The gasket device 5 in which the spacer 7 surrounds the gasket 6 from the inner side has a configuration in which the inner side and the outer side are reversed as compared with the gasket device 5 (FIG. 8) in which the spacer 7 surrounds the gasket 6 from the outer side.

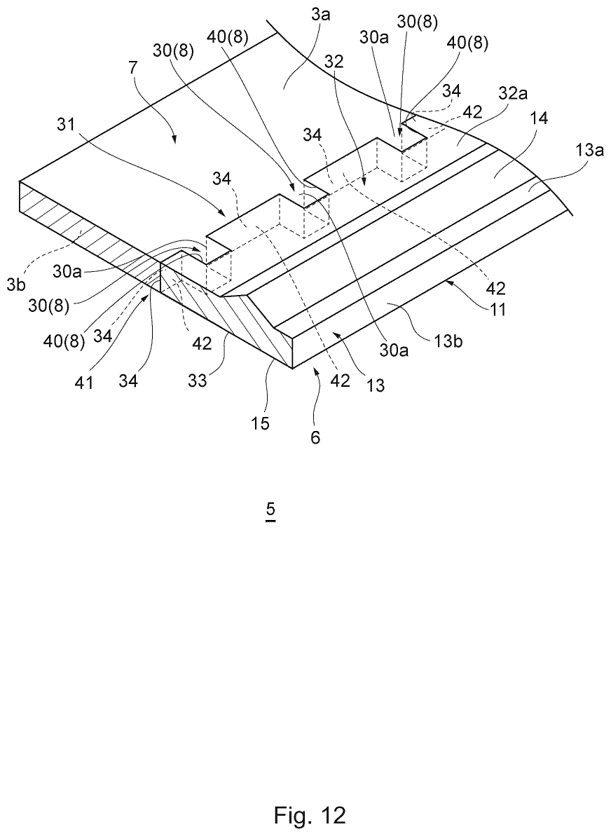

Moreover, as illustrated in FIG. 12, the gasket 6 may include the recessed portion 40 in place of the received portion 30 and the spacer 7 may include the received portion 30 in place of the recessed portion 40. In this case, the recessed portion 40 is disposed in the connecting portion 32 of the gasket 6 in a similar manner to the above-described received portion 30 and recessed from the contact surface 34 of the connecting portion 32. Moreover, the recessed portion 40 may or may not penetrate the connecting portion 132 in the opposed direction. The received portion 30 is disposed in the inner peripheral end surface 42 of the spacer 7 in a similar manner to the above-described recessed portion 40 and projects from the inner peripheral end surface 42. In this case, the gasket device 5 also works as the above-described gasket device 5 and produces similar effects.

The present disclosure is described through the above-described embodiments hereinabove but the technical scope of the present disclosure is not limited to the scope according to the above-described embodiments. It is obvious to those skilled in the art that a variety of modifications or improvements may be added to the above-described embodiments. It is obvious from the recitation in claims that a mode added with such a modification or an improvement is also within the technical scope of the present disclosure.

The embodiments described above are intended to facilitate the understanding of the present disclosure but not intended for a limited interruption of the present disclosure. Furthermore, the above-described embodiments are not intended to limit an application target to which the present disclosure is to be applied and the present disclosure may encompass, as the application target, any and all objects for which the present disclosure is usable. The components of the above-described embodiments and the locations, materials, conditions, shapes, sizes, and the like thereof are not limited to those described by way of example and may be modified, if necessary. For example, the present disclosure encompasses a difference generated in implementation, such as a manufacturing tolerance. Moreover, within the scope of technical consistency, the components described in the different embodiments may be partially replaced or combined. Moreover, the individual components may be selectively combined, if necessary, to achieve at least some of the problems to be solved and the effects described above.

For example, the forms of the received portions 10, 30 and the recessed portions 20, 40 of the engagement portions 4, 8 are not limited to the above-described forms. Moreover, although the sealing surface 15 of the sealing portion 11 of the gasket 2 or 6 is in a form of a flat surface or substantially in a form of a flat surface, the sealing surface 15 may be in a form of a non-flat surface such as a curved surface. For example, the sealing surface 15 may form a seal bead as the seal bead portion 14. Moreover, a groove may be formed on the sealing surface 15.

Moreover, a film may be attached to the gasket 2 or 6 in order to facilitate assembly with the spacer 3 or 7. In this case, for example, the gasket 2 or 6 in a shape or attitude in the gasket device 1 or 5 (in the assembled state) is placed on a sheet-shaped film (see FIGS. 2 and 8). Moreover, for example, the film removably sticks to the sealing surface 15. Thus, by unfolding the film, it is possible to provide the gasket 2 or 6 in the shape or attitude in the assembled state, which makes it possible to facilitate the assembly of the gasket 2 or 6 and the spacer 3 or 7.

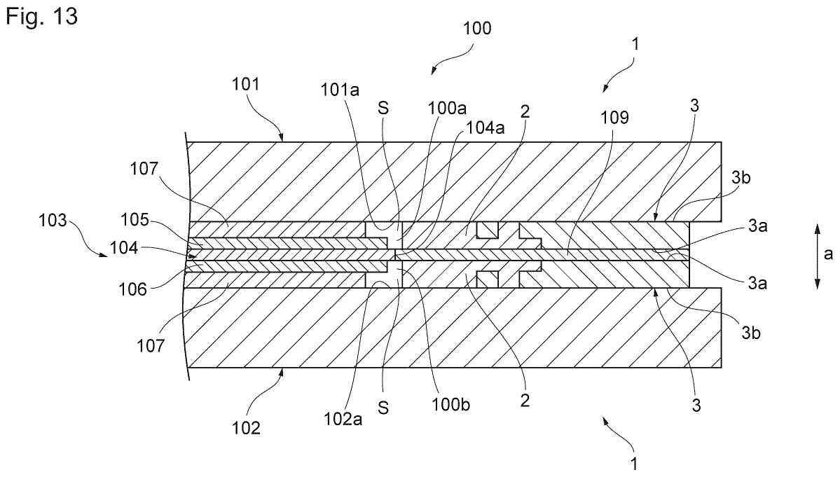

Moreover, the electrolyte membrane 104 of the membrane assembly 103 may be attached with a resin frame 109, which is an annular member made of resin, on the outer peripheral side so that the shape of the electrolyte membrane 104 is stabilized as illustrated in FIG. 13. In this case, in the cell 100, the gasket device 1 may be configured to come in to contact with the resin frame 109 as illustrated in FIG. 13. In other words, the seal bead portion 14 of the gasket 2 does not have to be configured to come into contact with the resin frame 109 and the surface 3a of the spacer 3 may be configured to come into contact with the resin frame 109. The resin frame 109 is in contact with an edge on the outer peripheral side (an outer peripheral edge 104a) of the electrolyte membrane 104 and extends around the entire outer peripheral edge 104a as illustrated in, for example, FIG. 13. Moreover, the resin frame 109 extends in a stretching direction of the electrolyte membrane 104 and is, for example, flush or substantially flush with the electrolyte membrane 104. The resin frame 109 is, for example, bonded to the electrolyte membrane 104 with an adhesive. Moreover, the resin frame 109 may be, for example, produced by an integral molding method. Specifically, for example, the resin frame 109 may be integrally molded with the electrolyte membrane 104 by placing the electrolyte membrane 104 in a mold in advance and pouring a resin, which is a material of the resin frame 109, into the mold. In the cell 100, the outer peripheral edge 104a of the electrolyte membrane 104, which is a boundary between the electrolyte membrane 104 and the resin frame 109, may be located farther on the inner side than the gasket 2 to be located between the two gaskets in the opposed direction as illustrated in FIG. 13. It should be noted that the catalysts 105, 106 are not sandwiched between the gaskets 2 and present farther on the inner side than the gaskets 2. The electrolyte membrane 104 attached with the resin frame 109 is likewise used for the gasket device 5.

1. A gasket device for sealing a space between opposed members, the gasket device comprising:
a gasket made of an elastic body; and
a spacer that is a member with rigidity for supporting, between the opposed members, the opposed members in a manner such that the opposed members are opposed with the space in between, wherein
the gasket is configured to surround the space between the opposed members,
the spacer is configured to surround the gasket from an outer side or an inner side between the opposed members, and
the gasket and the spacer are configured to come into contact with each other in a stretching direction of the space.

2. The gasket device according to claim 1, wherein
the gasket and the spacer include, at a contact portion where the gasket and the spacer are configured to come into contact with each other, an engagement portion configured to engage the gasket and the spacer with each other.

3. The gasket device according to claim 2, wherein
the engagement portion includes a recessed portion, which is a portion that is recessed, and a received portion, which is a portion to be received in the recessed portion,
the spacer includes, at a portion at an end on a side of the gasket in the stretching direction of the space, one of the at least one recessed portion and the at least one received portion, and
the gasket includes, at a portion at an end on a side of the spacer in the stretching direction of the space, another one of the at least one recessed portion and the at least one received portion.

4. The gasket device according to claim 3, wherein
the recessed portion is recessed in the opposed direction, and
the received portion extends in the opposed direction.

5. The gasket device according to claim 3, wherein
the recessed portion is recessed in the stretching direction of the space, and
the received portion extends in the stretching direction of the space.

6. The gasket device according to claim 4, wherein
the spacer includes a stepped portion at an end portion, the end portion being the portion at the end on the side of the gasket,
the stepped portion of the spacer has a first step surface that is a surface facing the side of the gasket and a second step surface that is a surface facing the side of the gasket, the second step surface being located farther on the side of the gasket than the first step surface, and
a peripheral end portion of the gasket is configured to, at least in an in-use state, come into contact with the first step surface and the second step surface of the stepped portion of the spacer, the peripheral end portion being the portion at the end on the side of the spacer.

7. The gasket device according to claim 1, wherein
the gasket includes a seal bead portion farther on a side opposite to the side of the spacer in the stretching direction of the space than the contact portion, the seal bead portion being a portion projecting toward one of the opposed members, and
the seal bead portion annularly extends.

8. The gasket device according to claim 1, wherein
the gasket is provided on a side of a target to be sealed with respect to the spacer.

9. The gasket device according to claim 1, wherein
the opposed members are a separator and an electrolyte membrane that are used in a cell of a water electrolysis device.

10. A gasket made of an elastic body for sealing a space between members, the members being supported by a spacer and opposed, the spacer being a member with rigidity, the gasket being configured to:
surround the space between the opposed members;
be surrounded by the spacer from an outer side or an inner side; and
come into contact with the spacer in a stretching direction of the space.

11. The gasket according to claim 10, comprising
an engagement portion at a portion to come into contact with the spacer, the engagement portion being configured to engage the gasket with the spacer.

12. The gasket according to claim 11, wherein
the spacer includes, at a portion at an end on a side of the gasket in the stretching direction of the space, one of at least one recessed portion and at least one received portion, the received portion being configured to be received in the recessed portion, and
the engagement portion includes, at a portion at an end on a side of the spacer in the stretching direction of the space, another one of the at least one recessed portion and the at least one received portion.

13. The gasket according to claim 12, wherein
the recessed portion is recessed in the opposed direction, and
the received portion extends in the opposed direction.

14. The gasket according to claim 12, wherein
the recessed portion is recessed in the stretching direction of the space, and
the received portion extends in the stretching direction of the space.

15. The gasket according to claim 13, wherein
the spacer includes a stepped portion at an end portion, the end portion being the portion at the end on the side of the gasket,
the stepped portion of the spacer has a first step surface that is a surface facing the side of the gasket and a second step surface that is a surface facing the side of the gasket, the second step surface being located farther on the side of the gasket than the first step surface, and
a peripheral end portion of the gasket is configured to, at least in an in-use state, come into contact with the first step surface and the second step surface of the stepped portion of the spacer, the peripheral end portion being the portion at the end on the side of the spacer.

16. The gasket according to claim 10, wherein
the gasket includes a seal bead portion farther on a side opposite to the side of the spacer in the stretching direction of the space than the contact portion, the seal bead portion being a portion projecting toward one of the opposed members, and
the seal bead portion annularly extends.

17. The gasket according to claim 10, wherein
the gasket is provided on a side of a target to be sealed with respect to the spacer.

18. The gasket according to claim 10, wherein
the opposed members are a separator and an electrolyte membrane that are used in a cell of a water electrolysis device.
